(19) United States
(12) Patent Application Publication
(10) Pub. No.: US 2023/0222538 A1
(43) Pub. Date: Jul. 13, 2023

(54) SYSTEM AND METHOD FOR MULTI CAMPAIGN OPTIMIZATION

(71) Applicant: Pandologic Ltd, Kfar Saba (IL)

(72) Inventors: Yigal GOLDFINE, Kfar Saba (IL); Amir KALDOR, Kfar Saba (IL)

(21) Appl. No.: 17/943,367

(22) Filed: Sep. 13, 2022

Related U.S. Application Data
(63) Continuation of application No. 17/401,569, filed on Aug. 13, 2021, now abandoned.

(51) Int. Cl. G06Q 30/0242; G06Q 10/1053

(52) U.S. Cl. CPC G06Q 30/0244; G06Q 10/1053

(57) ABSTRACT

A system and method for optimization of a plurality of campaigns for programmatic employment advertising. Preferably such optimization is guided according to the goals and parameters of each campaign.

### FIELD OF THE INVENTION

The present invention relates to a system and method for multi campaign optimization, and in particular, to such a system and method for optimization of a plurality of campaigns for programmatic employment advertising.

### BACKGROUND OF THE INVENTION

Job postings are required to find and hire suitable employees for various positions. Sometimes hiring occurs in bulk, for example when a new warehouse or other work center is opened, and/or seasonally (for example before the Christmas gift and package rush). In other cases, there may be an ongoing need for certain categories of workers, whether due to turnover and/or because some categories of workers are in high demand relative to supply. Currently, job postings are typically published online. While this increases convenience, it can also result in wasted time and money for employers due to non-suitable applicants.

Unlike other types of advertisements, job postings have greater, more complex requirements and publication parameters. Furthermore, the consequences of poor job posting strategy are likely to be higher than for normal consumer advertising strategy, for example. Unfortunately, there aren't currently any suitable tools which solve this problem specifically and effectively for job postings.

### BRIEF SUMMARY OF THE INVENTION

The background art does not teach or suggest a system or method for optimization of a plurality of campaigns for programmatic employment advertising. The background art also does not teach or suggest a system or method for such optimization according to the goals and parameters of each campaign.

The present invention overcomes the drawbacks of the background art by providing, in at least some embodiments, a system and method for optimization of a plurality of campaigns for programmatic employment advertising. Preferably such optimization is guided according to the goals and parameters of each campaign.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involve performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions. The processor is configured to execute a predefined set of operations in response to receiving a corresponding instruction selected from a predefined native instruction set of codes.

Software (e.g., an application, computer instructions) which is configured to perform (or cause to be performed) certain functionality may also be referred to as a “module” for performing that functionality, and also may be referred to a “processor” for performing such functionality. Thus, processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions—which can be a set of instructions, an application, software—which are operable on a computational device (e.g., a processor) to cause the computational device to conduct and/or achieve one or more specific functionality. Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a tablet or phablet, including without limitation an iPad, a thin client, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIGS. 1A-1C relate to exemplary, illustrative, non-limiting systems according to at least some embodiments of the present invention;

FIG. 2 relates to an exemplary, illustrative, non-limiting analysis engine, for example for implementation with the system of any of FIGS. 1A-1C, according to at least some embodiments of the present invention;

FIG. 3 relates to an exemplary, non-limiting method for adjusting a plurality of job posting campaigns according to at least some embodiments;

FIG. 4 relates to an exemplary, non-limiting detailed method for analyzing job posting campaigns for adjacency according to at least some embodiments;

FIG. 5 relates to an exemplary, non-limiting method for adjusting job postings by cluster;

FIG. 6 relates to an exemplary, non-limiting method for multi campaign analysis and adjustments; and

FIG. 7 relates to an exemplary, non-limiting method for determining campaign overlaps and adjusting the ad campaigns accordingly.

### DESCRIPTION OF AT LEAST SOME EMBODIMENTS

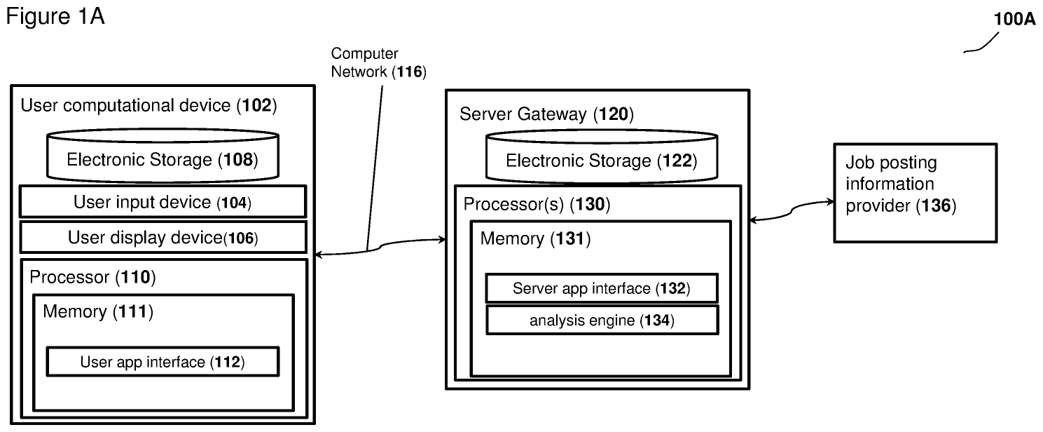

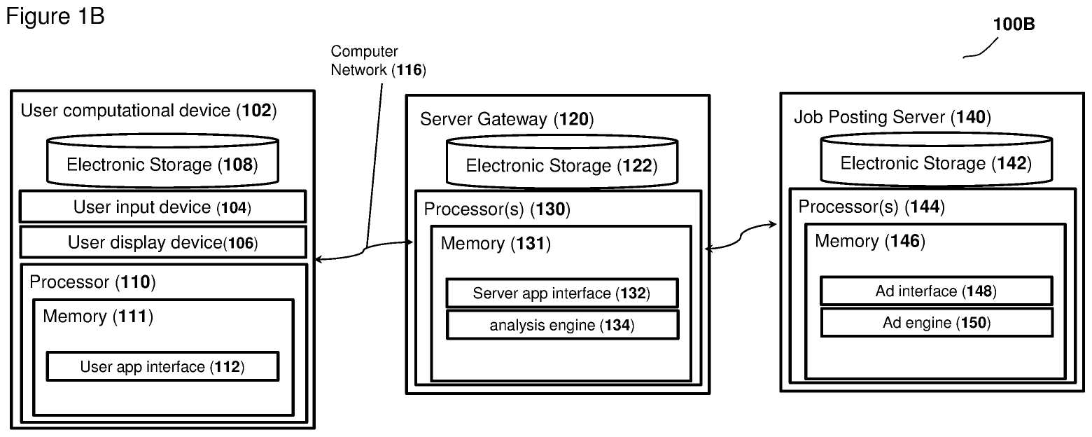

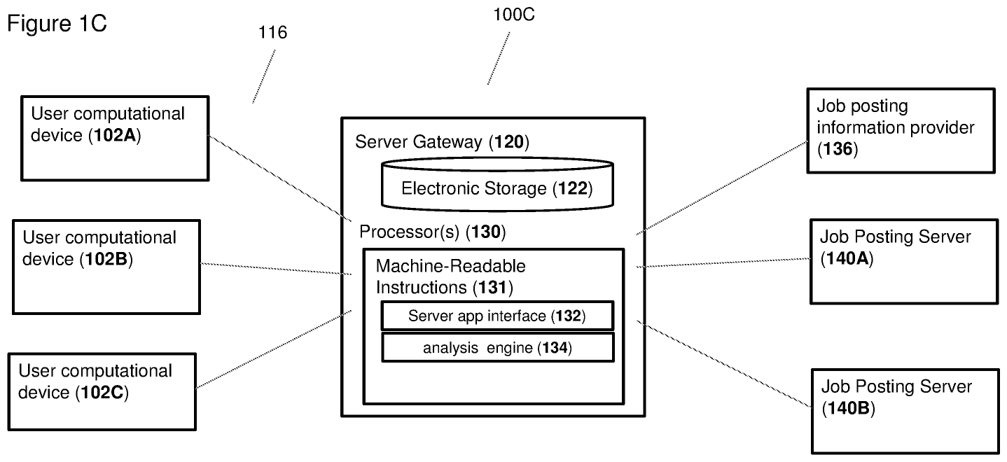

FIGS. 1A-1C relate to exemplary, illustrative, non-limiting systems according to at least some embodiments of the present invention. FIG. 1A shows an exemplary system 100A, featuring a user computational device 102 for being operated by a job posting creator user. As shown in the system 100A, there is provided a user computational device 102 in communication with the server gateway 120 through a computer network 116 such as the internet for example.

User computational device 102 includes the user input device 104, the user app interface 112, and user display device 106. The user input device 104 may optionally be any type of suitable input device including but not limited to a keyboard, microphone, mouse, or other pointing device and the like. Preferably user input device 104 includes a list, a microphone and a keyboard, mouse, or keyboard mouse combination.

User display device 106 is able to display information to the user for example from user app interface 112. The user operates user app interface 112 to provide job posting information and/or guidelines to an analysis engine 134 being operated by server gateway 120. This information is taken in from user app interface 112 through the server app interface 132. Analysis engine 134 preferably also has access to historical and optionally also real time job posting information, including with regard to publisher parameters, job posting success rates and bid prices. Such information may be stored at an electronic storage 122 associated with server gateway 120, may be provided through a job posting information provider 136 or from another source (not shown). Analysis engine 134 preferably provides the process for analyzing a plurality of job posting campaigns to consider adjacency and also optionally whether the campaigns are fulfilling one or more goals. Optionally analysis engine 134 also considers adjustments to the job postings. Each such job posting for the plurality of campaigns may be compared for example with regard to job title and job description, as well as job location. Optionally job location information is placed in the job title and/or job description, but may also be placed separately for publication, for example according to the format of the job posting publisher.

Also optionally, each job posting features associated publisher information, for example with regard to the total number of postings, job posting frequency, job posting timing, job posting location and/or position on a particular publication, including without limitation on a search results page; and so forth. Also optionally, each job posting features associated bid information, for example with regard to bid price, bid price range, any optional variations on bid price (for example with regard to timing during the day and/or week), and also optionally any connection between bid information and each publisher under consideration. Also optionally, each job posting features associated result information, for example with regard to the number of clicks, number of applicants, click to applicant ratio, click rate, applicant rate, cost per click, cost per applicant, number of hires, rate of hires, hire to applicant or hire to click ratio, cost per hire.

Optionally the job postings for the plurality of campaigns are adjusted, for example to prevent cannibalization of applicants across a plurality of campaigns and/or to prevent one campaign from failing to meet its goals, due to potential cannibalization because of adjacency. The job postings, optionally after such adjustment, may be sent directly to one or more publishers for publishing (not shown). Alternatively or additionally the job postings may be provided to user computational device 102, which in turn may then be directed by the user for transfer to one or more publishers for publishing (not shown).

User computational device 102 also comprises a processor 110 and a memory 111. Functions of processor 110 preferably relate to those performed by any suitable computational processor, which generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory, such as a memory 111 in this non-limiting example. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Also optionally, memory 111 is configured for storing a defined native instruction set of codes. Processor 110 is configured to perform a defined set of basic operations in response to receiving a corresponding basic instruction selected from the defined native instruction set of codes stored in memory 111. For example and without limitation, memory 111 may store a first set of machine codes selected from the native instruction set for receiving information and/or instructions from the user through user app interface 112 and a second set of machine codes selected from the native instruction set for transmitting such information to server gateway 120.

Similarly, server gateway 120 preferably comprises a processor 130 and a memory 131 with related or at least similar functions, including without limitation functions of server gateway 120 as described herein. For example and without limitation, memory 131 may store a first set of machine codes selected from the native instruction set for receiving information and/or instructions from user computational device 102, and a second set of machine codes selected from the native instruction set for executing functions of analysis engine 134. Memory 131 may store a third set of machine codes selected from the native instruction set for receiving historical and/or current job posting information from job posting information provider 136, for supply to analysis engine 134.

Optionally, historical and/or current job posting information, and/or previously performed analysis to determine adjacency of job posting campaigns, may be stored at an electronic storage 108 at user computational device 102 and/or at electronic storage 122 of server gateway 120.

FIG. 1B shows an exemplary system 100B. Components with the same reference number may have an identical or similar function as for FIG. 1A. System 100B features a job posting server 140 for receiving job postings, preferably with associated bid and/or publisher information, from analysis engine 134. Job posting server 140 may comprise a publisher network, in which case each publisher on the network may be separately identified and provided with a set of the above information that is specific to each such publisher. Optionally current and/or historical job posting information as described herein is provided by job posting information provider 136 (not shown) and/or by job posting server 140.

Job posting server 140 preferably comprises an ad engine 150 and an ad interface 148. Ad engine 150 preferably causes job postings to be published, according to information received from ad interface 148. Ad interface 148 preferably receives the job posting information from server gateway 120, according to the output of analysis engine 134, but alternatively receives the information from user computational device 102.

Job posting server 140 preferably comprises a processor 144 and a memory 146 with related or at least similar functions, including without limitation functions of job posting server 140 as described herein. For example and without limitation, memory 146 may store a first set of machine codes selected from the native instruction set for receiving information and/or instructions from server gateway 120, and a second set of machine codes selected from the native instruction set for executing functions of ad engine 150. Memory 146 may store a third set of machine codes selected from the native instruction set for providing historical and/or current job posting information to server gateway 120, for supply to analysis engine 134.

Information about previous job postings and their performance may be stored at electronic storage 142.

FIG. 1C shows an exemplary system 100C. Components with the same reference number may have an identical or similar function as for FIGS. 1A and/or 1B. Details from the components shown in FIGS. 1A and/or 1B may be assumed to be present, even if not shown, unless otherwise indicated. System 100C features a plurality of user computational devices 102A-102C as a non-limiting exemplary number, for preferably sending guidance and/or instructions to server gateway 120 and/or one or more other components shown, and preferably also for receiving job posting performance information from server gateway 120 and/or one or more other components shown. A plurality of job posting servers 140 are shown as 140A and 140B, without any intention of being limiting. Optionally one or more job posting server 140 comprises a job posting publisher network as described herein. Analysis engine 134 preferably receives current and/or historical job information from job posting information provider 136 and/or from one or more job posting server 140 for determining current and predicted job posting performance Analysis engine 134 also preferably determines the job posting tests and selected expansions according to such performance.

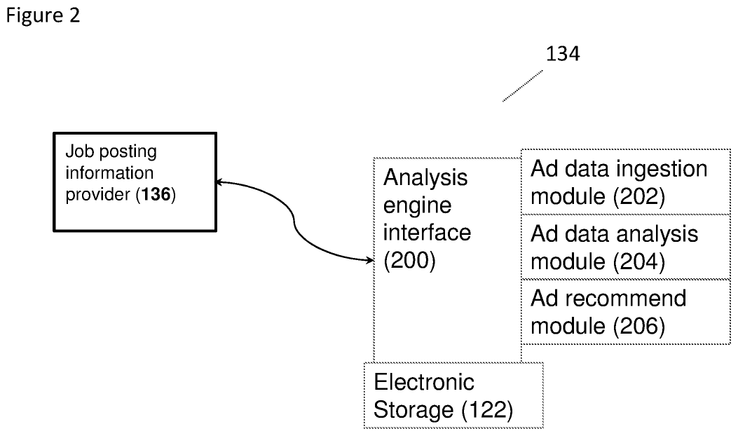

FIG. 2 relates to an exemplary, illustrative, non-limiting analysis engine, for example for implementation with the system of any of FIGS. 1A-1C, according to at least some embodiments of the present invention. As shown in a detailed implementation of analysis engine 134, an analysis engine interface 200 preferably receives a plurality of data inputs for analysis and then also provides the output result. Data inputs for analysis, related to job posting information, are received by an ad data ingestion module 202, preferably from job posting information provider 136. Such data preferably includes bid price, frequency and timing of job posting information by publisher, for historical and optionally also current job postings. Ad data ingestion module 202 preferably performs any necessary preprocessing.

After preprocessing, data is then fed to an ad data analysis module 204. Ad data analysis module 204 preferably determines which campaigns may be failing to meet their campaign goals and so should be analyzed for adjacency. Performance may be considered with regard to bid price, number of applicants applying for a job posting, rate of applicants applying, and number and/or rate of qualified applicants applying. Optionally performance is considered with regard to one or more historically trained models and/or according to one or more rules or guidelines.

Ad data analysis module 204 may retrieve additional information from, or store analysis results at electronic storage 122.

An ad recommendation module 206 preferably then receives the analysis from ad data analysis module 204 and prepares one or more output actions as previously described. Preferably, such output actions relate to adjusting one or more of job title, job description, selected publisher, publisher parameters such as number, frequency and/or timing of job posting publication, and/or bid price, to reduce or eliminate such adjacency.

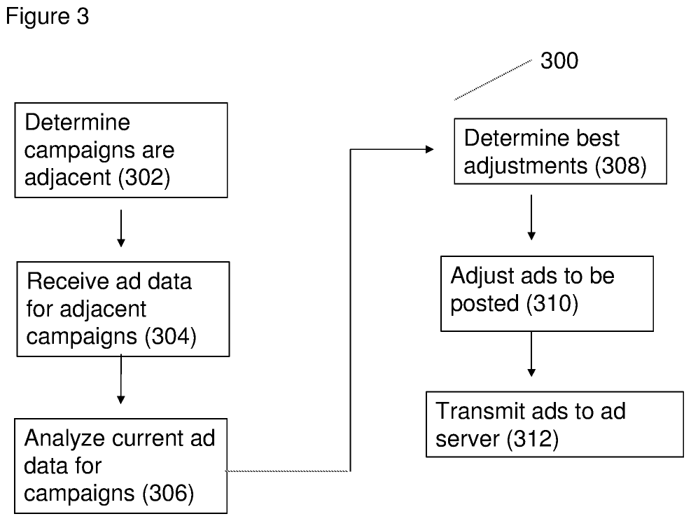

FIG. 3 relates to an exemplary, non-limiting method for adjusting a plurality of job posting campaigns according to at least some embodiments. As shown in a method 300, the process begins with by determining that a plurality of campaigns are adjacent at 302. Campaigns may be determined to be adjacent according to a plurality of campaign parameters, including but not limited to a geographical area for the jobs being advertised, the job title and/or role being advertised, job status (such as temporary or permanent, full or part time, flexi-work) and the goals of the campaigns. Preferably a plurality of such parameters are considered, as for example potential job applicants may not apply for the same plurality of jobs even if they are in the same geographical area and vice versa. Furthermore, if the plurality of campaigns are meeting their goals, optionally adjacency of the campaigns is potentially less problematic.

At 304, preferably ad data is received for the plurality of adjacent campaigns. The ad data preferably includes information about the job posting titles and descriptions, and more preferably also includes bidding and publisher information. The information included may relate to a plurality of variations on job title and job description, as well as job location. Optionally job location information is placed in the job title and/or job description, but may also be placed separately for publication, for example according to the format of the job posting publisher.

Also optionally, the job posting information features associated publisher information, for example with regard to the total number of postings, job posting frequency, job posting timing, job posting location and/or position on a particular publication, including without limitation on a search results page; and so forth. Also optionally, the job posting information features associated bid information, for example with regard to bid price, bid price range, any optional variations on bid price (for example with regard to timing during the day and/or week), and also optionally any connection between bid information and each publisher under consideration. Also optionally, the job posting information features associated result information, for example with regard to the number of clicks, number of applicants, click to applicant ratio, click rate, applicant rate, cost per click, cost per applicant, number of hires, rate of hires, hire to applicant or hire to click ratio, cost per hire.

At 306, current ad (job posting) data is analyzed, according to the above information, for example to consider trends with regard to any of the above items, including without limitation job title and/or description performance, bidding information and/or publisher performance.

For example and without limitation, such job posting data may relate to one or more of the number of impressions on the publication site, the relative location of the impressions on the publication site, the number of clicks, number of applicants, click to applicant ratio, click rate, applicant rate, cost per click, cost per applicant, number of hires, rate of hires, hire to applicant or hire to click ratio, and/or cost per hire.

At 308, the best adjustments for the plurality of job postings for the plurality of job campaigns are considered, to obtain a better performance. As noted above, preferably the campaign goals are considered first. For each campaign goal, preferably the extent to which the goal has been met or not met is determined. If a campaign goal is not being met, then preferably one or more adjustments to the job postings are made in order to assist the campaign goal in being met. By “better performance” it is meant a performance, as demonstrated by the job posting data, which is considered to be a higher level, as determined according to preferred job posting data performance criteria. For example, performance may be determined according to the combination of clicks, applicants and hires, in comparison to the amount of money and/or time spent.

Next, at 310, a plurality of job post adjustments are made, for example and without limitation, job title, geographical location and job description variations. Optionally a job post is withdrawn as part of the adjustment process. The adjusted ads (job postings) are then transmitted to a job posting publisher (ad server) for publication.

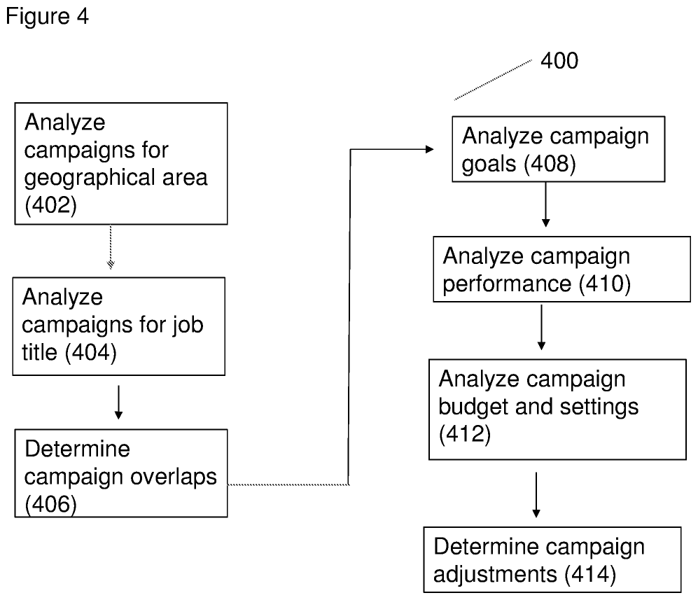

FIG. 4 relates to an exemplary, non-limiting detailed method for analyzing job posting campaigns for adjacency according to at least some embodiments. As shown in a method 400, the process starts at 402 by analyzing campaigns for geographical area, for example and without limitation, whether a plurality of job postings explicitly mention the same geographical area, or whether a job applicant may be expected to apply for a plurality of job postings in different geographical areas. Examples of the former may include explicit locations in a particular city, industrial area or zip code. Examples of the latter may include addresses that may be reasonably considered to be in an overlapping geographical area or within a similar commuting distance. Geographical locations may for example relate to city and/or state, zip code, county or parish, metropolitan area, location near or at a transportation artery or hub, location at or near a particular industrial area or office park, and so forth.

At 404, ads (job postings) are analyzed for job title adjacency. Such adjacency may relate to jobs with same or similar titles, or with titles that may be expected to appeal to similar job applicants in at least the geographical areas covered by the job campaigns. Job title synonyms may also be considered, for example with regard to the job role (secretary, warehouse worker, and so forth); and/or function (heavy lifting, clerical, and so forth). Optionally job titles may be analyzed with regard to job status, such as full vs part time, temporary vs permanent and so forth. Optionally geographical information is also included in a job title and so may be analyzed at this stage.

At 406, preferably job campaign adjacencies and overlaps are analyzed with regard to the above. Again, preferably both similar and identical information is considered, as well as information regarding overlaps that may be caused by potential or actually measured job applicant behavior. Optionally historical data regard such job applicant behavior may be considered at this stage.

At 408, the campaign goals for the adjacent campaigns are considered. For example, the goals may relate to a particular budget, a number of job applicants to be hired or at least to have apply, rate of application and/or hiring, and so forth. At 410, the actual performance of each campaign is analyzed, preferably to determine whether each campaign is fulfilling its goals. If each campaign is fulfilling its goals, optionally the process stops at this stage.

At 412, the budget and settings for each campaign are optionally analyzed if they were not analyzed previously. Even if the campaigns are meeting their goals, the budget and/or other settings may be analyzed to determine if further efficiencies may be gained.

At 414, optionally one or more campaign adjustments are determined according to the information and analyses from the above stages.

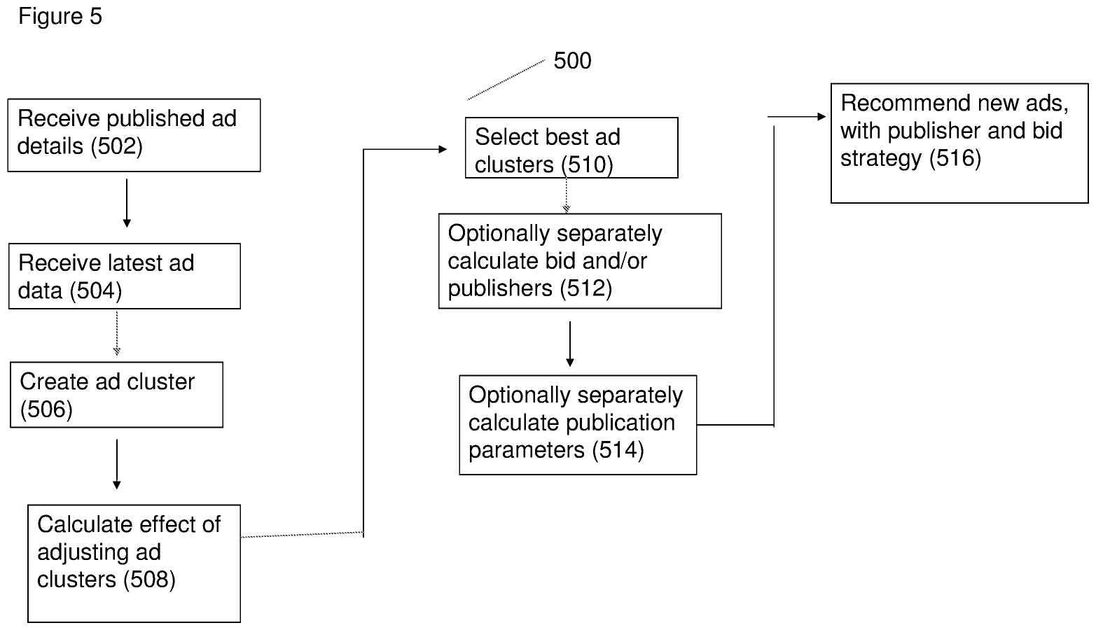

FIG. 5 relates to an exemplary, non-limiting method for adjusting job postings by cluster. In a method 500, the process starts at 502 by receiving published ad (job posting) details, for example and without limitation job title, job description, job location, job status (part vs full time, temporary vs permanent) and so forth.

The latest job posting data is then also received at 504, as described above, with regard to the performance of the published job postings. Next optionally a job posting cluster is created at 506, combining job title, location and text description, with bid strategy and publisher information. Multiple job posting clusters may contain or be associated with the same or similar job title, location and text description; conversely, multiple job posting clusters may also contain or be associated with the same or similar bid strategy and/or publisher information. Next, the effect of adjusting ad (job posting) clusters, for example as described above, is calculated at 508.

The best job posting clusters are then selected at 510, according to these calculations. By “best” it is meant job posting clusters that are calculated or estimated to have the best performance, as previously defined. Optionally the bid strategy and/or publisher strategy are separately calculated at 512, if one or both has not been calculated or estimated as part of the job posting cluster. Optionally, performance of job postings at particular publishers is analyzed previously, for example with regard to any of the above job posting results and/or including publisher specific criteria, including but not limited to one or more of number of impressions, relative placement on a job board page and/or within search results, and so forth. Optionally, performance of job postings with regard to a specific bid strategy is previously analyzed, for example with regard to any of the above job posting results and/or including bid strategy specific criteria, including but not limited to hourly, daily, weekly budget considerations, time required per job applicant, cost required per job and so forth.

Optionally the publication parameters are separately calculated at 514, if these parameters have not been calculated or estimated as part of the job posting cluster, and/or as part of the calculation or estimation at 512. At 516, optionally new ad (job posting) expansion and tiers, with publisher and bid strategy, are recommended or generated, for example if the job posting performance data falls below a certain threshold level of performance.

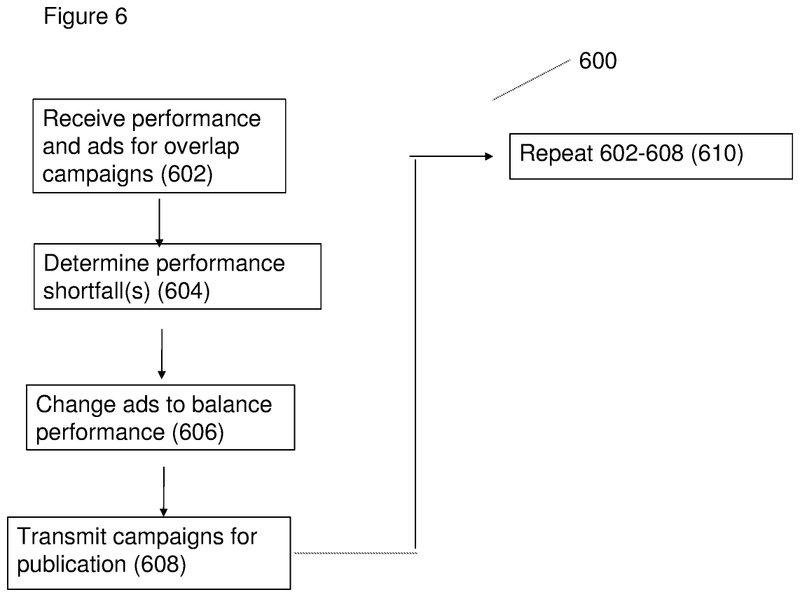

FIG. 6 relates to an exemplary, non-limiting method for multi campaign analysis and adjustments. As shown with regard to a method 600, performance and ads for overlap campaigns are received at 602. Optionally the campaigns are determined to be overlapping as previously described. Alternatively they may be assumed to be overlapping without additional analysis. At 604, one or more performance shortfalls are determined, for example as previously described. For example and without limitation, such performance shortfalls may be determined according to number of job applicants for each job posting, rate of application, budget and/or overall cost for such applicants, number and/or rate of hires and so forth.

At 606, one or more ads (job postings) may be adjusted to overcome such performance shortfalls, for example as previously described. For example, if one job posting campaign is cannibalizing applicants from another campaign, optionally the first job posting campaign is adjusted to prevent such cannibalization. Such adjustments may relate to a difference in geographical area description, job role description, where the job posting is published and so forth.

At 608, the adjusted campaigns are then transmitted for publication. Stages 602-608 may be repeated at stage 610.

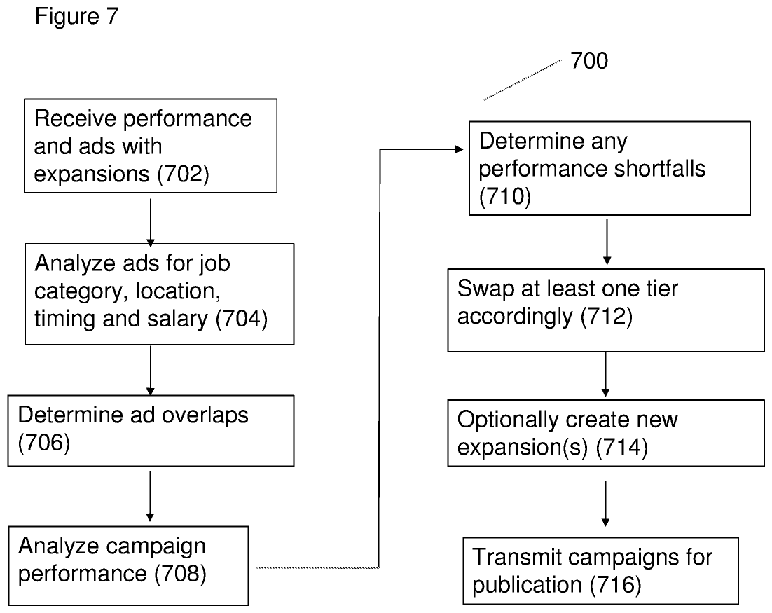

FIG. 7 relates to an exemplary, non-limiting method for determining campaign overlaps and adjusting the ad campaigns accordingly. In a method 700, the process preferably begins at 702 with receiving performance and ads with expansions. Optionally such expansions are created according to U.S. patent application Ser. No. 17/200,762 filed on Mar. 12, 2021, for “SYSTEM AND METHOD FOR PROGRAMMATIC EMPLOYMENT ADVERTISING”, owned in common with the instant application and with at least one inventor overlap with the instant application. According to at least some embodiments, the system first creates a plurality of different job posting title and text variants, as an expanded set of job postings or “expansion”. Optionally particular feature(s) are selected for expansion, such as for example job posting location or geography, job title, description and so forth. Such particular feature(s) may be selected according to historical data. Optionally all expanded job postings are considered for testing, but alternatively, the set of job postings may be initially limited according to an analysis of historical data. Each job posting may be associated with a bid and publisher selection to form a job cluster, but if not, then bid and publisher selection is preferably also performed according to historical data.

Expanded job postings may optionally be grouped into tiers. The alpha tier relates to the currently most successful job posting strategy or strategies, while gamma tier job postings are variants on the job posting(s) in the alpha tier. Job postings in the beta tier are preferably regularly tested; if one or more proves to be more successful than an alpha tier job posting, the beta tier job posting is moved up to the alpha tier, while the alpha tier job posting is removed. Gamma tier job postings that are associated with the newly removed alpha tier job posting are also removed. New job postings that are associated with the newly promoted alpha tier job posting, as variants, are added to the gamma tier.

At 704, ads (job postings) are analyzed for job category, location, timing and salary, for example as described above. Job category may relate to the type of job role or position as described above. Job location may be determined according to geographical area as described above. Timing may relate to job posting timing, for example with regard to timing during the day and/or week. At 706, job posting overlaps may be determined, for example as previously described.

At 708, job campaign performance is analyzed for a plurality of job campaigns, preferably as described herein. At 710, optionally any performance shortfalls are determined, for example as described herein. At 712, optionally one or more tiers of job postings are swapped, to bring in new or different job postings, to replace job postings that are underperforming and/or that are cannibalizing postings from a different campaign. For example, the performance of different job campaigns may be analyzed, preferably to determine which alpha tier job posting is still top performing and also whether to swap out an alpha tier job posting for a beta tier job posting. Performance may be considered with regard to bid price, number of applicants applying for a job posting, rate of applicants applying, and number and/or rate of qualified applicants applying. Optionally performance is considered with regard to one or more historically trained models and/or according to one or more rules or guidelines.

At 714, optionally one or more new expansions are created, in order to adjust performance of the plurality of campaigns. Optionally such expansions are created according to selected areas for expansion that are received, for example and without limitation job title, job description, job location and so forth. The expansions may then be created by constructing a plurality of variations for each selected area. The combined expansion variations may then be used to create the one or more new expansions.

At 716, the adjusted campaigns are preferably transmitted for publication.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for optimizing published job postings across a plurality of campaigns, the system comprising:
a user computational device for sending one or more job posting campaign performance goals;
a server gateway for receiving said one or more performance goals, job posting campaign performance data and also for receiving job posting parameters, including a plurality of job title synonyms and job text descriptions,
a viewer computational device, comprising a web browser for viewing a job posting; and
a computational network for connecting said user computational device, said viewer computational device and said server gateway;
said server gateway comprising an analysis engine for analyzing said one or more performance goals, said job posting campaign performance data and said job posting parameters; wherein said analysis engine analyzes said job posting campaign performance data by comparing a plurality of job posting campaigns to determine if one of said plurality of job posting campaigns is cannibalizing another of said job posting campaigns according to adjacency of one or more of geographic area and job role description;
wherein said server gateway receives job posting campaign performance data from said job posting publisher and adjusts at least one job posting in at least one campaign according to said analysis from said analysis engine, and transmits said adjusted job posting to said job posting publisher;
wherein said job posting publisher publishes said adjusted job posting to said web browser, such that said web browser displays said adjusted job posting.

2. The system of claim 1, wherein said analysis engine determines that at least one job posting campaign has an overlap with at least one other job posting campaign according to said adjacency of one or more of geographic area and job role description, and then determines that said overlap is resulting in a reduced performance.

3. The system of claim 2, wherein said analysis engine adjusts at least one job posting according to one or more of job title and synonyms, job description, geographical location, full/part-time in title, and encouraging words in said job title.

4. The system of claim 2, wherein said job posting campaign performance data comprises one or more of bid price, frequency and timing of job posting information by publisher.

5. The system of claim 4, wherein said job posting campaign performance data is received for historical and current job postings.

6. The system of claim 5, wherein said job posting parameters comprise a geographical area for said job posting; wherein said overlap between a plurality of job posting campaigns is determined according to an overlap in said geographical area; wherein at least one of said plurality of job posting campaigns is adjusted by changing at least one job posting to form an adjusted job posting, such that said web browser displays said adjusted job posting.

7. The system of claim 6, wherein said server gateway optimizes said geographical area and wherein said adjusted job posting includes said optimized geographical area.

8. The system of claim 7, wherein said server gateway determines said geographical area according to a commuting distance to a location of said job posting and according to location near or at a transportation artery or hub.

9. The system of claim 8, wherein said server gateway adjusts at least one job posting in at least one campaign by changing a job role description.

10. The system of claim 9, wherein said server gateway adjusts at least one job posting in at least one campaign by changing a job posting publisher.

11. The system of claim 10, wherein said server gateway adjusts at least one job posting in at least one campaign by changing a location description.
